(19) United States
(12) Patent Application Publication
(10) Pub. No.: US 2015/0280622 A1
(43) Pub. Date: Oct. 1, 2015

(54) METHOD AND DEVICE FOR OPERATING AN ELECTRONICALLY COMMUTATED ELECTRIC MACHINE

(71) Applicant: ROBERT BOSCH GMBH, Stuttgart (DE)

(72) Inventors: Torsten Wilharm, Buehl (DE); Martin Bergt, Karlsruhe (DE); Dirk Eisenblaetter, Baden-Baden Neuweier (DE)

(73) Assignee: Robert Bosch GmbH, Stuttgart (DE)

(21) Appl. No.: 14/439,398

(22) PCT Filed: Oct. 21, 2013
(86) PCT No.: PCT/EP2013/071969

§ 371 Date: Apr. 29, 2015

(30) Foreign Application Priority Data
Oct. 30, 2012 (DE) 10 2012 219 797.4

(51) Int. Cl. H02P 6/08

(52) U.S. Cl. CPC H02P 6/08

(57) ABSTRACT

The invention relates to a method for operating an electronically commutated electric machine (2), having the following steps: Activating a driver circuit (3) in accordance with a commutation schema by switching power semiconductor switches (32, 33); applying a pulse width modulation to the switching of the power semiconductor switches (32, 33); and limiting a pulse control factor of the pulse width modulation to a pulse control factor threshold value.

### BACKGROUND OF THE INVENTION

The present invention relates to electronically commutated electric machines, in particular to measures for protecting an electronically commutated electric machine from overload, in particular from too high phase or line-to-line currents.

Electronically commutated electric machines are frequently operated with the aid of an inverter. By specifying a commutation pattern, the inverter is actuated in such a way that said inverter energizes or deenergizes phase connections of the electric machine as a function of a rotor position of the electric machine. In addition, the phase voltage to be applied can be varied in the inverter with the aid of a pulse width modulation and therefore an adjustment of the power for the variable actuation of the electric machine can be carried out.

With the aid of a pulse width modulation, the inverter is adjusted for the variable setting of the motor torque or, respectively, the load torque by means of specifying a pulse control factor. The phase voltage to be applied via the two affected phase connections is modulated by means of the pulse width modulation in order to reduce the effectively applied phase voltage in accordance with the pulse control factor. To this end, a cyclical actuation model is provided, wherein the pulse control factor indicates the ratio of a time period for which the supply voltage is applied to the phase connections of the electric machine to a predefined cycle time period.

In order to protect the electric machine and the inverter from damage as a result of inadmissibly high amperages, provision is usually made for current limitation and an over-current shutdown. Although the damaging effect as a result of a phase current exceeding a current threshold value can occur in only one phase, the individual phase currents are not monitored for reasons of cost, but rather the DC link current as a sum of the individual phase currents.

Furthermore, because the current measurement essentially performs an averaging due to the EMC-compliant design, DC link currents are measured in particular at small pulse control factors of the pulse width modulation, said DC link currents being considerably lower than the actual current flow through a straight energized phase of the electric machine. The current limitation or over-current shutdown can therefore not intervene in some cases, in particular at low pulse control factors, although the phase currents can already become inadmissibly high in the event of sluggishness or blockage of flow.

The pulse control factor of the pulse width modulation often cannot be easily applied to the current threshold value that is critical for the current limitation due to the capabilities of the hardware of the control device and/or the inverter. Current limiters for components used in bridge circuits are particularly designed in such a manner that they generally provide a fixed current threshold value which, when exceeded, triggers a shutdown. The current threshold value can therefore not easily be manipulated.

It is the aim of the present invention to provide an improved method for operating an electric machine, with which it is possible to prevent an overcurrent in a phase or phase element of the electric machine even at low pulse control factors.

### SUMMARY OF THE INVENTION

The aforementioned aim is met by the method for operating an electronically commutated electric machine according to the invention as well as by the device, the system and the computer program product according to the invention.

According to a first aspect, a method for operating an electronically commutated electrical machine is provided, comprising the following steps:
actuating a driver circuit in accordance with a commutation schema by switching power semiconductor switches;
applying a pulse width modulation to the switching of the power semiconductor switches; and
limiting a pulse control factor of the pulse width modulation to a pulse control factor threshold value.

In addition, the pulse control factor threshold value can be determined as a function of a current rotational speed of the electric machine.

It is a concept of the aforementioned method to limit the pulse control factor to be adjusted to a predefined limit value. In particular, the pulse control factor can be limited to a value dependent on a rotational speed of the electric machine. This is particularly useful for drives with a load characteristic in which the torque requirement significantly increases with the rotational speed, in particular in which the torque requirement increases linearly or quadratically with respect to the rotational speed, wherein a limitation of the phase voltage, i.e. a limitation of the effective voltage applied to the phase connections of the electric machine, is performed. In this way, a reliable current limitation can be implemented substantially independently of the size of the predefined pulse control factor, wherein the applied phase voltages are limited as a function of the current rotational speed of the electric motor rather than the motor current.

As a result, the event can be precluded that too high of a motor current is not detected by the current limitation or overcurrent shutdown mechanisms when a low pulse control factor prevails. This non-detection occurs because the current measurement provides only an average value or a smoothed value of the current flowing through the electric machine.

In particular, the pulse control factor threshold value can be determined in accordance with a predefined pulse control threshold value characteristic diagram or a predefined pulse control factor threshold value function.

According to a further embodiment, either a motor current, which results from a current balance of phase currents at phase connections of the electric machine, can be limited or an overload current shutdown can be performed when a maximum current is exceeded by the motor current.

Provision can be made for the pulse control factor of the pulse width modulation to be determined in accordance with a predefined actuation function as a function of a target value.

According to a further aspect, a device, in particular a control unit, for operating an electrically commutated electric machine is provided, wherein the device is designed to:
activate a driver circuit in accordance with a commutation schema by switching power semiconductor switches,
apply a pulse width modulation to the switching of the power semiconductor switches; and
limit a pulse control factor of the pulse width modulation to a pulse control factor threshold value.

According to a further aspect, a system is provided, comprising:
an electronically commutated electric machine;
a driver circuit comprising power semiconductor switches in order to actuate the electric machine by switching the power semiconductor switches; and
a control unit which is designed to:
   activate the power semiconductor switches in accordance with a commutation schema;
   apply a pulse width modulation to the switching of the power semiconductor switches; and
   limit a pulse control factor of the pulse width modulation to a pulse control factor threshold value.

According to a further aspect, a computer program product is provided which contains a program code that carries out the aforementioned method if said program code is executed on a data processing device.

### BRIEF DESCRIPTION OF THE DRAWINGS

Preferred embodiments of the present invention are explained below in detail with the aid of the attached drawings. In the drawings:

FIG. 1 shows a schematic depiction of a motor system comprising a driver circuit and a three-phase electric machine;

FIG. 2 shows a diagram used to depict operating ranges of the electric machine; and

FIG. 3 shows a flow diagram used to illustrate a method for operating the electric machine.

### DETAILED DESCRIPTION

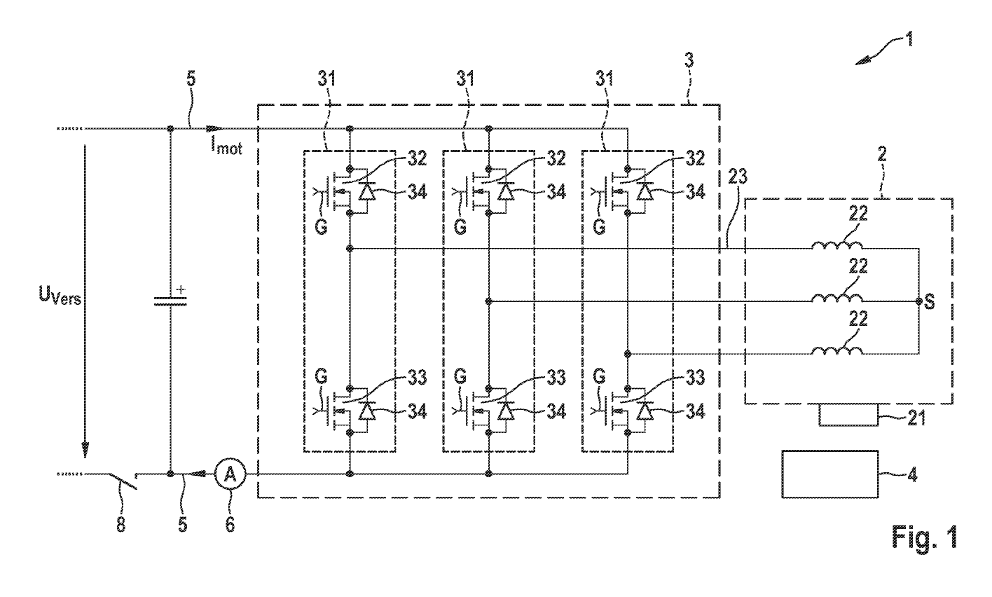

FIG. 1 shows an electrical schematic diagram comprising an electric machine 2, a driver circuit 3 and a control unit 4 as a depiction of a motor system 1.

The electric machine 2 is provided as an electronically commutated electric machine, in particular as a three-phase electric machine. In particular, the electric machine 2 can be designed as a synchronous machine or as an asynchronous machine. The electric machine 2 is provided with a position sensor 21 in order to detect a rotor position of the electric machine 2 and to provide a corresponding item of information to the control device 4. As an alternative, an item of information about the rotor position can also be ascertained without a sensor by evaluating phase current profiles.

A stator arrangement of the electric machine 2 comprises stator coils 22 or stator coil arrangements, which are interconnected to one another in a star-point connection via a common star point S. The respectively other connections of the stator coils 22 constitute the phase connections 23 of the electric machine 2 for ensuring an energy flow to and from the electric machine 2. In an alternative embodiment, the stator coils 22 can also be interconnected in a delta connection.

In the case of the three-phase electric machine, the driver circuit 3 has substantially a corresponding number of (three) inverter circuits 31 which provide a corresponding phase actuation at the phase connections 23 of the electric machine 2. Each of the inverter circuits 31 has a first power semiconductor switch 32 (pull-up branch) and a second power semiconductor switch 33 (pull-down branch) which are connected in series with each other. A supply voltage Uᵥₑᵣₛ is applied by means of corresponding voltage supply lines 5 via the series circuit of the first and second power semiconductor switch of each of the inverter circuits 31.

The power semiconductor switches 32, 33 can be designed as semiconductor components, such as, for example, power MOSFETs, thyristors, IGBTs, IGCTs and the like. The power semiconductor switches 32, 33 each have an antiparallel-connected free-wheeling diode 34 in order to be able to discharge a negative current flow occurring as a result of an induced voltage.

A tap for respectively one of the phase connections 23 is provided at a node between the first power semiconductor switch 32 and the second semiconductor switch 33 of each of the inverter circuits 31. Each of the power semiconductor switches 32, 33 can be separately actuated via the control connection G thereof and, to that end, connected to the control unit 4.

The driver circuit 3 mentioned above is generally referred to as a B6-circuit. Alternatively, other configurations of driver circuits are also possible, such as, for example, H-circuits or something similar.

The control unit 4 controls the power semiconductor switches 32, 33 in accordance with a commutation schema which specifies at which point in time in which of the phase connections 23 a current is to flow into the electric machine 2 and from which of the phase connections 23 a current from the electric machine 2 is to flow. Such a commutation can take place in such a way that a first of the power semiconductor switches 32 of one of the inverter circuits 31 and a second of the power semiconductor switches 33 of a further of the inverter circuits 31 can be switched such that the same are closed and form a low-impedance current path, while all of the remaining power semiconductor switches 32, 33 are open and thus are of high impedance. By switching the first and second power semiconductor switches 32, 33 as a function of the rotor position ascertained by the position detector 21 or in a manner without a sensor, it is possible to generate a stator magnetic field which is rotating and leads an excitation magnetic field of the rotor, in order to thereby produce a propelling torque.

In order to be able to adjust the driving torque provided by the electric machine 2 and in addition to the commutation schema, the phase voltage that is to be effectively applied to the phase connection 23 during a corresponding commutation phase is adjusted with the aid of a pulse width modulation. To this end, those power semiconductor switches 32, 33 which are to be closed are actuated in a pulse-width modulated manner by specifying a pulse control factor; thus enabling the phase connections 23 to effectively be only subjected to a reduced voltage. The pulse control factor specifies the ratio of a duty cycle of the affected power semiconductor switch 32, 33 to a predefined cycle time period. In other words, the pulse control factor specifies the proportion of the duty cycle to the entire cycle time period. As a result, the voltage that is effectively applied to the phase connections 23 can be linearly adjusted as a function of the pulse control factor.

A current detector 6, which detects the entire motor current provided to the driver circuit 3, is located in the supply voltage line 5 via which the supply voltage Uᵥₑᵣₛ is applied to said driver circuit 3. The current detector 6 performs a smoothing of the measured current values due to the EMC-compliant design thereof, so that a specification of a smoothed or averaged motor current is always made available.

In particular at low pulse control factors of the pulse width modulation, the full supply voltage Uᵥₑᵣₛ with the resulting current flow is, however, applied across the two phase connections 23 during a switch-on time window, the duration of which corresponds to the product from the pulse control factor and the predefined cycle time period; whereas no voltage is applied and therefore no current flows in the remaining amount of the cycle time period because the relevant power semiconductor switches 32, 33 are switched off. This can, however, lead to a high current flow, which in certain circumstances is greater than an admissible phase current, during the switch-on time window of cycle time period, during which the voltage is applied to the corresponding phase connections 23.

In existing motor systems, the motor system is limited by suitable measures in order to avert damage to the driver circuit 3 or to the electric machine 2. A current limitation or an overcurrent shutdown can thus be provided by a switch-off element further being provided in the supply voltage lines 5. Upon detecting a current value of the motor current Iₘₒₜ over a predefined current threshold value Iₘₐₓ, the switch-off element can be opened in a controlled manner by the control unit 4, and the motor system 1 can consequently be switched off.

If only a current measurement is performed in supply voltage lines 5, it is then impossible to determine a resulting current value in the phase conductors of the electric machine which exceeds a current limit value for the relevant phase conductor.

Particularly in operating conditions in which, for example, the measured motor current Iₘₒₜ is significantly lower than the actual phase current flowing in the electric machine 2 due to the pulse control factor, a further measure is implemented in the control unit 4 which ensures that the phase currents do not exceed a predefined phase current threshold value. To this end, a voltage limitation is implemented in the control unit 4.

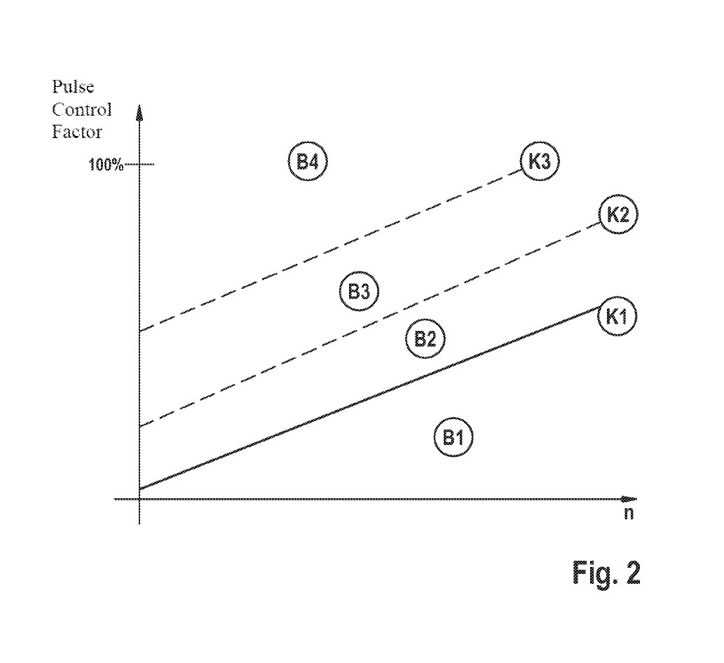

In FIG. 2, the behavior of an exemplary motor system in a selected application is depicted with the aid of a diagram, wherein the pulse control factors T are plotted over the rotational speed n at normal operating conditions. The curve K1 shows the profile of the pulse control factor T as a function of the rotational speed to be achieved at normal operating conditions. In the case of blockage or sluggishness of current flow or an increased load, the control unit 4 will select a pulse control factor T which is greater than the pulse control factor specified by the curve K1. At a lower load than at normal operating conditions, the pulse control factor to be applied is selected from a region B1 beneath the curve K1.

The region designated with the reference sign B2 comprises those pulse control factors which exceed the pulse control factors T that are predefined by the curve K1 with respect to a certain rotational speed n and at which no critical currents occur in the phase conductors of the electric machine 2.

The region B2 is upwardly limited by the curve K2. The curve K2 describes a separation line to a region B3, in which the pulse control factors are so high with regard to the rotational speed n that critical phase currents can occur. The current limitation and the overcurrent shutdown are not capable of detecting said critical phase currents due to the smoothing behavior of the current detector 6. The region B4 denotes the region above a curve K3 in which the current measurement by the current detector 6 ascertains an overcurrent and correspondingly shuts down the motor system 1 by switching the switching element 8. The diagram of FIG. 2 represents an exemplary application in which the motor system 1 can be operated. In alternative applications, the linear curve profiles of the curves K1 and K2 depicted in FIG. 2 can also have other, non-linear profiles.

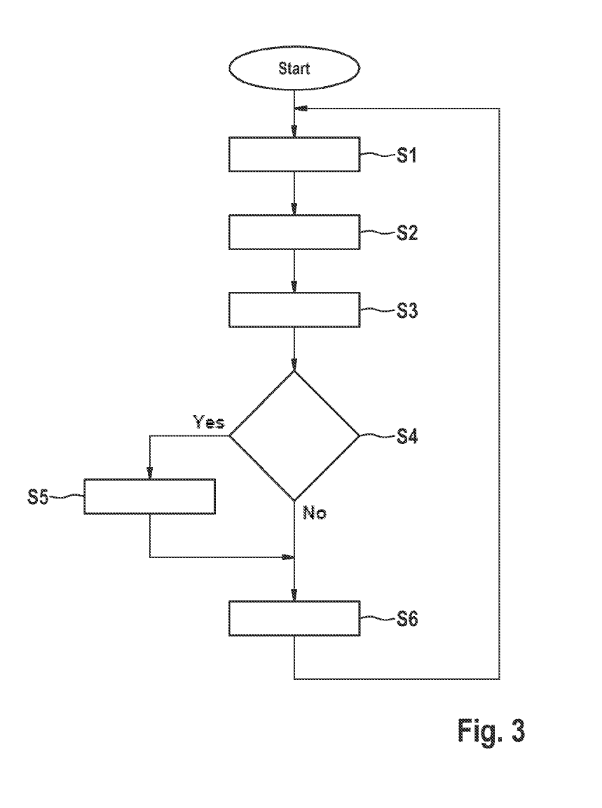

A flow diagram for illustrating the method for operating the motor system 1 is depicted in FIG. 3.

In step S1, the current rotational speed of the electric machine 2 is initially detected, in particular with the aid of the position detector 21 or without a sensor. The rotational speed n can particularly be found by the temporal evaluation of the change in the detected rotor position.

In a subsequent step S2, a pulse control factor is ascertained by the control unit 4 in accordance with a predefined algorithm, which ensues in accordance with the application from the current rotational speed n or other external specifications and conditions.

In step S3, a pulse control factor threshold value Tₜₕ associated with the current rotational speed n is ascertained, for example from a pulse control factor threshold value function or from a corresponding characteristic diagram. The curve K2 specifies the profile of the pulse control factor threshold value Tₜₕ for the relevant exemplary application. The pulse control factor threshold value Tₜₕ indicates a maximum value for the pulse control factor, which may not be exceeded because otherwise inadmissibly high phase currents could occur.

A check is now made in step S4 as to whether the pulse control factor ascertained in step S2 exceeds the pulse control factor threshold value Tₜₕ ascertained in step S3. If this is the case (alternative: Yes), the method will then proceed with step S5. Otherwise (Alternative: No), the method directly proceeds with step S6.

In step S5, the pulse control factor T ascertained in step S2 is limited to the pulse control factor threshold value Tₜₕ, and thus it is ensured that the electric machine 2 is not actuated with a larger pulse control factor than that which corresponds to the pulse control threshold value Tₜₕ.

In the subsequent step S6, the electric machine is actuated in accordance with the pulse control factor T or, respectively, with the limited pulse control factor.

In addition to the limitation of the pulse control factor T, which corresponds to a limitation of the phase voltages applied to the phase connections 23, the current limitation or the overcurrent shutdown described above can be implemented in order to also ensure a protection against undesirable operating conditions for high pulse control factors, in which inadmissibly high motor current can occur.

1. A method for operating an electronically commutated electric machine (2), having the following steps:
Activating a driver circuit (3) in accordance with a commutation schema by switching power semiconductor switches (32, 33);
Applying a pulse width modulation to the switching of the power semiconductor switches (32, 33); and
Limiting a pulse control factor (T) of the pulse width modulation to a pulse control factor threshold value (Tₜₕ).

2. The method according to claim 1, wherein the pulse control factor threshold value (Tₜₕ) is determined as a function of a current rotational speed of the electric machine (2).

3. The method according to claim 2, wherein the pulse control factor threshold value (Tₜₕ) is determined according to a predefined pulse control factor threshold value characteristic diagram.

4. The method according to claim 1, wherein a motor current, which results from a current balance of phase currents at phase connections of the electric machine (2), is furthermore limited when a maximum current is exceeded by the motor current.

5. The method according to claim 1, wherein the pulse control factor (T) of the pulse width modulation is determined according to a predefined actuation function as a function of a target value.

6. A control unit (4) for operating an electronically commutated electric machine (2), wherein the control unit (4) is designed to:
actuate a driver circuit (3) in accordance with a commutation schema by switching power semiconductor switches (32, 33);
apply a pulse width modulation to the switching of the power semiconductor switches (32, 33); and
limit a pulse control factor of the pulse width modulation to a pulse control factor threshold value (Tₜₕ).

7. A system, comprising:
an electronically commutated electric machine (2);
a driver circuit (3) comprising power semiconductor switches (32, 33) in order to actuate the electric machine (3) by switching the power semiconductor switches (32, 33); and
a control unit (4) which is designed to
actuate the power semiconductor switches (32, 33) in accordance with a commutation schema;
apply a pulse width modulation to the switching of the power semiconductor switches (32, 33); and
limit a pulse control factor of the pulse width modulation to a pulse control factor threshold value (Tₜₕ).

8. A computer program which is equipped to carry out all of the steps of a method according to claim 1.

9. A non-transitory electronic storage medium, in which a computer program according to claim 8 is stored.

10. An electronic control device which comprises an electronic storage medium according to claim 9.

11. The method according to claim 2, wherein the pulse control factor threshold value (Tₜₕ) is determined according to a predefined pulse control factor threshold value function.

12. The method according to claim 1, wherein an overcurrent shutdown is performed when a maximum current is exceeded by a motor current which results from a current balance of phase currents at phase connections of the electric machine (2).
